(19) United States
(12) Patent Application Publication
(10) Pub. No.: US 2025/0191042 A1
(43) Pub. Date: Jun. 12, 2025

(54) Power-Assisted Hand Tool, and Method for Ordering an Article

(71) Applicant: Würth International AG, Chur (CH)

(72) Inventors: Adrien Marquette, Schwäbisch Hall (DE); Louisa Aschoff, Neuenstein (DE)

(21) Appl. No.: 18/846,049

(22) PCT Filed: Mar. 9, 2023
(86) PCT No.: PCT/EP2023/056040

§ 371 Date: Sep. 11, 2024

(30) Foreign Application Priority Data
Mar. 16, 2022 (DE) 10 2022 202 594.6

(51) Int. Cl. G06Q 30/0601; B25F 5/00

(52) U.S. Cl. CPC G06Q 30/0613; B25F 5/00

(57) ABSTRACT

A power-assisted hand tool, in particular an electrically or pneumatically operated hand tool, in particular a cordless screwdriver, a pneumatic nailer, a caulking gun, a drill, a saw or an angle grinder, that has an identification device for identifying an article, in particular an article that is driven and/or can be processed with the hand tool, and having a transmission device for transmitting a data record that identifies the article.

### FIELD OF THE INVENTION

The invention relates to a power-assisted hand tool, in particular an electrically or pneumatically operated hand tool, in particular a cordless screwdriver, a pneumatic nailer, a caulking gun, a drill, a saw or an angle grinder. The invention also relates to a method for ordering an article by means of a power-assisted hand tool according to the invention.

### BACKGROUND

Power-assisted hand tools are used to screw in screws, to insert nails or for grouting, for example. For this purpose, a worker takes the articles to be processed, for example screws, to their workplace. With forward planning, the worker takes his daily requirement or slightly more than his daily requirement to his workplace. At the workplace, on a construction site for example, in general there is no simple way of reordering articles which have run out. Normally the worker must then either telephone or he must leave his workplace and personally procure the missing articles. If the worker realizes that he will probably run out of the required article the next day or in the course of the week, he must remember to reorder the missing article in the evening after returning to his workshop or in the morning.

### SUMMARY

The invention is intended to improve a power-assisted hand tool and a method for ordering an article by means of a power-assisted hand tool.

For this purpose, according to the invention, a power-assisted hand tool is provided, in particular an electrically or pneumatically operated hand tool, in particular a cordless screwdriver, a pneumatic nailer, a caulking gun, a drill, a saw or an angle grinder, having an identification device for identifying an article, in particular an article that is driven and/or can be processed with the hand tool, and having a transmission device for transmitting a data record that identifies the article.

With the hand tool according to the invention, an article can be identified and also a data record that identifies the article can be transmitted with the transmission device. This creates the prerequisites for ordering the identified article by means of the hand tool itself. For example, a worker at his workplace on the construction site can identify the screws he is processing and then reorder these screws by transmitting a data record that identifies the screws. To initiate the order, however, the worker does not have to leave his workplace. Therefore, not only does he saves time but also this avoids the worker still having to deal with reordering articles outside of his actual working time. The transmission device can work wirelessly, for example, by means of WLAN, by wire using LAN, by means of Bluetooth, GSM, LTE or 5G. For example, the transmission device can also transmit the data record to a cell phone, in particular a smartphone, of the worker, and an application running on the smartphone can then perform the actual order.

In a development of the invention, an interface device is provided for the initiation of the transmission of the data record by means of the transmission device by an operator of the hand tool.

If the transmission of the data record is not intended to take place automatically after the identification of an article, a button can be provided on the hand tool, for example, or an interface device in the form of a touch-sensitive display. For example, on the display the worker can then check whether the article has been identified correctly and then send off the data record that also contains a quantity of the required article, for example.

In a development of the invention, the interface device is designed to generate information relating to an urgency or prioritization of an order of the article.

For example, a different prioritization can be set so that standard delivery is made to the workshop, or so that express delivery is made to the construction site itself if the work needs to be completed as quickly as possible.

In a development of the invention, the interface device has an actuation button for initiating the transmission of the data record.

In a development of the invention, the interface device has a display device, in particular a display.

In a development of the invention, the identification device has an RFID reading device, a reading device for reading a code on the article and/or at least a camera and an electronic image processing unit.

If the article is provided with an RFID chip, the RFID chip can be read out. When they are read out, RFID chips normally send a unique identifier. This identifier in turn can then be assigned to a data record in order to identify an article. In the context of the invention, an article is considered to be a product, a component or a small part, in particular a screw, a nut or a dowel, but also a package having a plurality of small parts, for example a package having a plurality of screws, nuts or the like. In the case of small parts, the package can be provided with an RFID chip that is then read out by the identification device. The identification device can also read a code, for example, in particular a QR code, a barcode or a number code on the article, for example on a cartridge or on a package, and thereby identify the article. The identification device can also have a camera and an electronic image processing unit. For example, a camera and an electronic image processing unit can be used to identify a screw itself or another small part. However, a camera and electronic image processing unit can also be used, for example, to read and identify a number code, a QR code or a barcode on an article, for example a cartridge or a package having a plurality of small parts.

In a development of the invention, a control unit is provided for the setting of processing parameters for the article on the basis of the identification of the article.

After the article has been identified by means of the identification unit, processing parameters for the identified article can be set automatically or only after confirmation by the operator on the hand tool. These processing parameters can either be stored in a memory of the hand tool itself or a request can be made to a database in order to obtain processing parameters for the identified article. Processing parameters can be a rotational speed, a torque, an impact force, a feed rate or the like, for example.

In a development of the invention, a data record is created when the article is identified, wherein the created data record contains processing parameters relating to the product.

The processing parameters can contain rotational speed, change in the rotational speed over time, a torque, a change in the torque over time, an impact force or the like, for example.

In a development of the invention, the hand tool has a device for identifying an operator of the hand tool.

In this way, a work procedure carried out with the hand tool can be documented. The identifying of an operator can take place, for example, by means of a fingerprint sensor, a reading device for an employee ID card or by an interface device for inputting a personal identification number (PIN).

In a development of the invention, the hand tool has a mobile unit and a base station, wherein the base station has a receiving device for receiving the data record from the transmission device.

In this way, the hand tool itself can be constructed easily and simply, because only the identification device and the transmission device need to be provided in the hand tool itself. The receiving device can then be arranged in the base station. The base station can be formed by the charging station of a battery-operated hand tool, for example.

The problem on which the invention is based is also solved by a method for ordering an article by means of a power-assisted hand tool according to the invention, wherein the steps of identifying the article by means of an identification device on the hand tool, creating a data record that identifies the article and transmitting the data record by means of a transmission device on the hand tool are provided.

In this way, the hand tool itself can be used to order an article. After the article has been identified, a data record that identifies the article can be transmitted and this data record can either initiate an order immediately or be processed further, not necessarily automatically, to then finally lead to an order. For example, the data record transmitted by the hand tool can also be stored on a workshop computer and then be added by an operator to a bulk order, on a daily basis for example.

In a development of the invention, the receiving and processing of the data record is provided in a base station of the hand tool or in a computer unit separate from the hand tool.

In the case of a battery-operated hand tool, the base station of the hand tool can be the battery charging station, for example. A computer unit separate from the hand tool can be a tablet or a notebook of the worker, for example, or a workshop computer. In this way, the order can be checked, a delivery can be initiated and/or the order can be forwarded to a store on the construction site or to a central warehouse.

In a development of the invention, authorization of an order is checked when the data record is processed.

In this way, unauthorized orders can be avoided.

In a development of the invention, an order quantity is determined taking into account an average consumption of the article when the data record is processed.

For example, when the data record is processed, a check is made as to which quantities of the ordered article were consumed in a predefined period, for example the preceding working week. Accordingly, the order quantity can then be determined, by ordering the weekly requirement for example.

In a development of the invention, an urgency or prioritization of the order is taken into account when the data record is processed.

In a development of the invention, the order is forwarded to different storage locations depending on the urgency or prioritization.

For example, very urgent orders are forwarded to a construction site store, whereas less urgent orders are given to a central warehouse.

Further features and advantages of the invention emerge from the claims and the following description of a preferred embodiment of the invention in conjunction with the accompanying drawings. In the drawings:

### BRIEF DESCRIPTION OF THE DRAWINGS

FIG. 1 shows a schematic depiction of a hand tool according to the invention.

### DETAILED DESCRIPTION

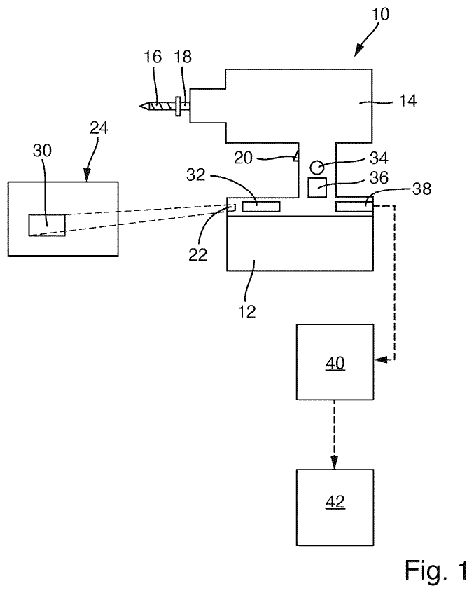

FIG. 1 shows a hand tool 10 according to the invention that is designed as a so-called cordless screwdriver. The hand tool 10 has an electric motor, not depicted, and a battery 12, which is fitted to a housing 14 of the hand tool. Screws 16 can be screwed in or unscrewed, for example, with the hand tool 10. To set a screwdriver bit 18 of the hand tool 10 in rotation, a trigger switch 20 is provided on the handle of the hand tool 10.

In the context of the invention, the screw 16 forms a so-called article. The screw 16 can be processed with the hand tool 10. In the context of the invention, packages having a plurality of screws 16 are also referred to as articles. In the context of the invention, the hand tool 10 can also be designed, for example, as a pneumatic nailer, caulking press, angle grinder, drill or the like.

If articles, for example screws 16, are processed with the hand tool 10, it can happen that the supply of screws 16 runs out during the work. To facilitate reordering of the article, the hand tool 10 is provided with an identification device 22. The identification device 22 is designed as an RFID reading device. The identification device 22 thus emits an electric field that is received by the antenna of an RFID chip. The electrical energy produced by the receiving of the transmission signal is then used to cause the RFID chip, for its part, to emit a signal. This signal contains a unique identifier, normally a number, which is assigned to the RFID chip. Since the identifier of the RFID chip exists only once, a specific article can be assigned to this identifier.

In FIG. 1, an article 24 is depicted in the form of a package for a plurality of screws 16, wherein the package 24 is provided with an RFID chip 30. The identifier of the RFID chip 30 can be read out by means of the identification device 22. The identifier itself can already represent the data record that identifies the article 24, since the identifier, as explained, exists only once and is unique.

However, in the context of the invention, it is also possible to provide a memory 32 in the hand tool 10, by means of which the identifier of the RFID chip 30 is then assigned to a data record which then in turn identifies the article. In addition, processing parameters for the article 24 or the screws 16 of the article 24 which are contained in the package can also be stored in the memory 32. These processing parameters can relate to rotational speed, torque, rotational speed profile, torque profile and the like, for example. In the context of the invention, it is envisioned that the processing parameters determined by means of the memory 32 are set automatically or only after confirmation by the operator on the hand tool 10.

After the article 24 has been identified by means of the identification device 22, an operator has the possibility to reorder the article 24 with the hand tool 10. For this purpose, an interface device with an actuation button 34 and a display unit 36 is provided on the hand tool 10. For the sake of completeness, it is noted that the actuation button 34 is different than the trigger switch 20 for operating the hand tool 10.

If an operator or worker wishes to reorder the article 24, that is to say the package having a plurality of screws 16, he can press on the actuation button 34. The order number of the article 24, for example, is displayed in the display 36. In the context of the invention, however, the display device 36 can also be omitted. Actuating the actuation button 34 activates a transmission device 38, which then sends a data record identifying the article 24 to a computer unit 40. The transmission of the data record by the transmission device 38 is symbolized by means of a dashed arrow. The computer unit 40 can be arranged in a base station of the hand tool 10, for example, in a charging station for the battery 12 for example. However, the computer unit 40 can also be a workshop computer or a mobile computer unit, for example a smartphone, a tablet or a notebook.

In the computer unit 40, the data record obtained from the hand tool 10 can be checked once again and/or processed further. For example, an order can be initiated immediately. Data records from a plurality of hand tools or a plurality of data records from the hand tool 10 can also be collected and then combined to form one order. The order is then forwarded to a further computer unit 42, for example a warehouse management computer or the like, to initiate the order.

With the invention, it is possible for an operator or worker to initiate an order for reordering an article, for example the screw 16 or the article 24 in the form of a package for a plurality of screws 16, directly at their workplace, for example on the construction site, with the hand tool 10 itself. The worker thereby saves time, and in particular when he requires further screws 16 very quickly, he can initiate such an urgent and pressing order directly with the hand tool 10.

1. A power-assisted hand tool that is an electrically or pneumatically operated cordless screwdriver, pneumatic nailer, caulking gun, drill, saw or angle grinder, comprising
an identification device for identifying an article that is driven and/or can be processed with the hand tool, and
a transmission device for transmitting a data record that identifies the article.

2. The power-assisted hand tool as claimed in claim 1, further including an interface device for the initiation of the transmission of the data record by means of the transmission device by an operator of the hand tool.

3. The power-assisted hand tool as claimed in claim 2, wherein the interface device is designed to generate information relating to an urgency or prioritization of an order of the article.

4. The power-assisted hand tool as claimed in claim 2, wherein the interface device has an actuation button for initiating the transmission of the data record.

5. The power-assisted hand tool as claimed in claim 2, wherein the interface device has a display.

6. The power-assisted hand tool as claimed in claim 1, wherein the identification device has an RFID reading device, a reading device for reading a code on the article and/or at least a camera and an electronic image processing unit.

7. The power-assisted hand tool as claimed in claim 1, further including a control unit for the setting of processing parameters of the hand tool for the article on the basis of the identification of the article.

8. The power-assisted hand tool as claimed in claim 7, wherein a data record is created when the article is identified, and in that the created data record contains processing parameters relating to the article.

9. The power-assisted hand tool as claimed in claim 1, wherein the hand tool has a device for identifying an operator of the hand tool.

10. The power-assisted hand tool as claimed in claim 1, wherein the hand tool has a mobile unit and a base station, further wherein the base station has a receiving device for receiving the data record from the transmission device.

11. A method for ordering an article by means of a power-assisted hand tool as claimed in claim 1, further including identification of the article by means of an identification device on the hand tool, creation of a data record that identifies the article and transmission of the data record by means of a transmission device on the hand tool.

12. The method as claimed in claim 11, further including receiving and processing of the data record in a base station of the hand tool or in a computer unit separate from the hand tool.

13. The method as claimed in claim 12, further including checking of authorization of an order when the data record is processed.

14. The method as claimed in claim 12, further including determination of an order quantity taking into account an average consumption of the article when the data record is processed.

15. The method as claimed in claim 12, further including the taking into account of an urgency or prioritization of the order when the data record is processed.

16. The method as claimed in claim 15, further including forwarding of the order to different storage locations depending on the urgency or prioritization when the data record is processed.
